(19) United States
(12) Patent Application Publication
(10) Pub. No.: US 2007/0037061 A1
(43) Pub. Date: Feb. 15, 2007

(54) Polymer electrolyte complex

(76) Inventors: Peter V. Wright, Sheffield (GB); Yungui Zheng, Sheffield (GB)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 10/556,673

(22) PCT Filed: May 11, 2004
(86) PCT No.: PCT/GB04/02050

§ 371 Date: Nov. 14, 2005

(30) Foreign Application Priority Data
May 13, 2003 (GB) 03109527
May 13, 2003 (GB) 03109535

(51) Int. Cl. H01M 10/40; C08J 5/20

(52) U.S. Cl. 429/317; 521/25; 429/309

(57) ABSTRACT

A polymer electrolyte being configured to provide ion transport, said polymer electrolyte comprising: a main-chain first repeating unit configured to provide a primary ion coordinating site, a plurality of main-chain repeating units being arranged as a substantially helical ion coordinating channel; said polymer electrolyte further comprising and being characterised by: a main-chain second repeating unit being interdispersed between said main-chain first repeating unit, said second repeating unit being configured to provide a secondary ion coordinating site within said coordinating channel, said secondary ion coordinating site being less coordinating then said primary ion coordinating site; wherein said polymer electrolyte is configured to provide ion transport within said coordinating channel involving ion transport between said primary ion coordinating site and said secondary ion coordinating site.

### FIELD OF THE INVENTION

The present invention relates to polymers and in particular, although not exclusively, to organised polymer electrolyte complexes configured for ion transport.

### BACKGROUND OF THE INVENTION

Within the field of polymer electrolytes four distinct types of material, reflecting four different mechanistic approaches to ion mobility, have been recognised. i) The translation of lithium salts through liquid solvents in gels or ‘hybrid’ materials of various kinds. ii) Solvent-free, salt—polymer complexed systems in which the ion motion is coupled to the micro-brownian motion of segments of the polymer chains above the glass or melting transitions of the system. iii) ‘Single-ion’ systems, in which the lithium ion moves by a hopping process between anionic sites fixed to the polymer chain, or systems with reduced mobility of anions (solvent—containing or solvent-free). iv) Solvent-free, salt-polymer complexed systems in which ion mobility is uncoupled to the motions of polymer chain segments.

The drive towards solvent-free polymer electrolytes stems from the hazards associated with the highly reactive lithium (currently used within batteries) in contact with low-molecular weight solvents. This is especially apparent for heavy-duty battery applications in which operation at elevated temperatures might be anticipated. Accordingly a very real risk of fire and explosion is to be associated with heavy-duty applications of such conventional lithium—organic solvent batteries.

Conventionally, solvent-free polymer electrolytes have been largely based upon complexes of lithium salts in amorphous forms of polyethylene oxide (PEO), this polymer dissolves lithium salts to give semi-crystalline or fully amorphous complex phases where ion migration through the amorphous phases gives rise to significant conductivity; M. B. Armand, in J. R. MacCallum, C. A. Vincent (Eds) Polymer Electrolyte Reviews 1, Elsevier, London, 1987, Chapter 1; G. Cameron and M. D. Ingram, in J. R. MacCallum, C. A. Vincent (Eds) Polymer Electrolyte Reviews 2, Elsevier, London, 1989, Chapter 5.; F. M. Gray, Polymer Electrolytes, the Royal Society of Chemistry, Cambridge, UK, 1997, Chapter 1. Ion mobilities in these systems are free-volume dependent and are essentially coupled to the segmental mobilities of the rubbery polymer, the conductivity, σ, generally following a strong temperature dependence. Whilst conductivities at temperatures above ca. 80° C. approach 10⁻³ S cm⁻¹, which is adequate for successful operation of lithium batteries at such temperatures, a variety of strategies have thus far failed to bring about conductivities greater than ca. 10⁻⁴ S cm⁻¹ at ambient temperatures (ca. 25° C.).

In particular, the application of amorphous forms of PEO in ambient temperature batteries, requiring conductivities of ca. 10⁻³ S cm⁻¹ is prohibited due to their low ambient conductivity. Other amorphous systems giving conductivities between 10⁻⁴ to 10⁻⁵ S cm⁻¹ have been proposed C. A. Angell. C. Liu and E Sanchez. Nature. 1993. 362. 137.; F. Croce. C. Appetecchi. L. Persi and B. Scrosati. Nature. 1998. 394. 456.

In an attempt to address the low ambient temperature conductivities associated with PEO based electrolytes, various extended helical crystalline structures of PEO-alkyl salt complexes have been proposed forming organised low-dimensional polymer complexes, Y. Chatani and S. Okamura. Polymer. 1987 28. 1815.; P. Lightfoot. M. A. Mehta and P. G. Bruce. Science. 1993. 262. 883.; Y. G. Andreev. P. Lightfoot. And P. g. Bruce. J. Appl. Crystallogr., 1997. 18. 294; F. B. Dias. J. P. Voss. S. V. Batty. P. V. Wright and G. Ungar. Macromol. Rapid Common., 1994. 15. 961.; F. B. Dias. S. V. Batty. G. Ungar. J. P. Voss. And P. V. Wright. J. Chem. Soc., Faraday Trans., 1996. 92. 2599.; P. V. Wright. Y. Zheng. D Bhatt. T. Richardson and G. Ungar. Polym. Int., 1998. 47. 34.; Y. Zheng. P. V. Wright and G. Ungar. Electrochim. Acta. 2000., 45. 1161.; Y. Zheng. A Gibaud. N . cowlam. T. H. Richardson. G. Ungar and P. V. Wright. J Mater. Chem., 2000. 10. 69, Yungui Zheng, Fusiong Chia, Goran Ungar and Peter. V. Wright, Chem. Commun., 2000, 1459-1460.

Of these most recent solvent-free low-dimensional polymer electrolyte blends, a helical polymer backbone provides support for alkyl side-chains which interdigitate in a hexagonal lattice layer between the polyether helical backbones. Cations are encapsulated within the helices, one per repeat unit/helical turn, where the anions lie in the interhelical spaces. These three-component systems incorporate a long chain n-alkyl or alkane molecule, the inclusion of which provides increased conductivities resulting from highly-organised lamellar textures where the long chain n-alkyl or alkane molecule is embedded between lamellar layers.

However, such solvent-free polymer electrolyte complexes still exhibit unsatisfactory temperature dependent conductivities in addition to unsatisfactory conductivity levels at ambient temperature.

What is required therefore is a solvent-free electrolyte exhibiting reduced temperature dependent conductivities and/or increased conductivity at ambient temperature operating conditions.

### SUMMARY OF THE INVENTION

The inventors provide improved solvent-free polymer electrolytes capable of conductivities over the range 10⁻⁴ S cm⁻¹ to 10⁻² S cm⁻¹ at ambient temperatures.

According to known solvent-free electrolyte complexes ion migration is provided via helical ionophilic polyether based coordinating channels, providing in turn, ion motion being largely de-coupled notwithstanding minimal local conformational motions of the polyether backbones. Following a realisation of enhanced ion mobility in such ionophilic channels, the inventors provide ion coordinating pathways being configured with oxygen-rich primary ion coordinating sites and oxygen-deficient secondary ion coordinating sites. Owing to the creation of ion conducting channels within an ordered polymer complex comprising regions of ion coordinating sites being interdispersed with coordinating site ‘spaces’ or ‘voids’ enhanced ion mobility is achieved.

The inventors provide both a polymer electrolyte and a method of synthesising the same so as to provide a ‘tunable’ polymeric self-organising ion conducting species configured to provide adjustable levels of ion conductivity, being dependent upon a ratio of primary ion conducting sites (oxygen-rich) to secondary ion conducting sites (oxygen-deficient) within the ion conducting channel(s).

According to specific embodiments of the present invention the ratio of primary ion coordinating sites to secondary ion coordinating sites may be greater or less being dependent upon the synthetic route employed. In particular, the polymer electrolyte may comprises a mixture of 15 to 25 mol % of repeating units comprising the primary ion coordinating sites and 75 to 85 mol % of repeating units comprising the secondary ion coordinating sites. For example, reactants, solvents and/or reaction parameters may be varied so as to achieve a desired ratio of primary ion coordinating sites to secondary ion coordinating sites. Particularly, relative proportions of a co-solvent of dimethylsulphoxide (DMSO) and tetrahydrofuran (THF) may be varied. For example, variation of a type and/or molar quantity of a more polar solvent within a co-or multi-solvent system may be utilised in order to selectively synthesis a copolymer of desired oxygen-rich to oxygen-deficient repeating unit content forming the main-chain polymeric backbone.

According to a specific implementation of the present invention ion coordinating channels are formed from polyether backbones involving an oxygen-rich repeating unit, providing primary ion coordinating sites, being interdispersed with an oxygen-deficient repeating unit providing secondary ion coordinating sites, the secondary ion coordination sites being configured to coordinate ions to a lesser extent than the primary sites.

Additional components within the polymer electrolyte complex may comprise a first and/or second ionic bridge polymer configured to enhance conductivity levels and reduce temperature dependent conductivity characteristics. In response to a de-blending heating process, the ion conducting polymer(s) establish a lamellar and/or micellar morphology, the ion coordinating channels being provided in such organised textures. This first and/or second ionic bridge polymer(s) sit(s) between the lamellar or micellar regions serving to provide an ionic bridge between amphiphilic channels so as to offset any reduction in conductivity resulting from ion conducting polymer lattice shrinkage in response to temperature reduction.

According to a further specific implementation of the present invention the ionophilic coordinating channels may be constructed solely from the secondary ion coordinating sites.

According to a first aspect of the present invention, there is provided a polymer electrolyte being configured to provide ion transport, said polymer electrolyte comprising: a main-chain first repeating unit configured to provide a primary ion coordinating site, a plurality of main-chain repeating units being arranged as a substantially helical ion coordinating channel; said polymer electrolyte further comprising and being characterised by: a main-chain second repeating unit being interdispersed between said main-chain first repeating unit, said second repeating unit being configured to provide a secondary ion coordinating site within said coordinating channel, said secondary ion coordinating site being less strongly coordinating than said primary ion coordinating site; wherein said polymer electrolyte is configured to provide ion transport within said coordinating channel involving ion transport between said primary ion coordinating site and said secondary ion coordinating site.

Preferably, said main-chain first repeating unit and/or said main-chain second repeating unit comprise a hydrocarbon side-chain extending from said main-chain repeating unit, said hydrocarbon side-chain being configured to interdigitate with hydrocarbon side-chains of neighbouring main-chain repeating units.

Preferably, said ion coordinating channel is oxygen-rich at said primary ion coordinating site; and said ion coordinating channel is oxygen-deficient at said secondary ion coordinating site.

Preferably, said main-chain first repeating unit comprises a plurality of methylene-oxy-methylene linkages and said main-chain second repeating unit comprises a single methylene-oxy-methylene linkage.

Preferably, said polymer electrolyte comprises a plurality of substantially helical ion coordinating channels being formed from a plurality of main-chain first and second repeating units arranged as a lattice by interdigitation of the hydrocarbon side-chains.

Preferably, ion transport within said coordinating channel is configured to be substantially decoupled from conformational motion of said main-chain first and second repeating unit.

Preferably, the polymer electrolyte comprises a second polymer comprising ionophilic polyoxyalkylene units.

Preferably, the second polymer is positioned between said lattice of said plurality of main-chain first and second repeating units.

According to a second aspect of the present invention, there is provided a copolymer comprising repeating units being represented by general formula (1) and (2): 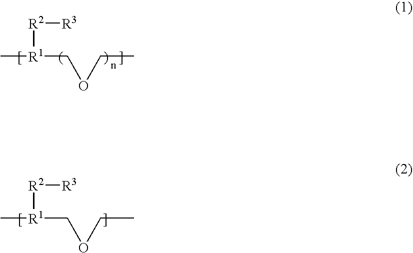
where R¹ is alkylene or a benzene nucleus; R² is oxygen, nitrogen, alkylene, phenylene or CH₂; R³ is alkyl, phenyl or alkyl-phenyl and 8≧n≧2, preferably n is 5.

Preferably, R¹ is a benzene nucleus, R² is oxygen and R³ is a substantially straight chain hydrocarbon preferably —(CH₂)ₘ—H where 30≧m≧5, more preferably m is 12, 16 or 18.

Preferably, R¹ is CH, R² is oxygen and R³ is a substantially straight chain hydrocarbon preferably —(CH₂)ₘ—H where 30≧m≧5, more preferably m is 12, 16 or 18.

Preferably, said copolymer comprises a combination of said straight chain hydrocarbon where m is 12 and 18.

Preferably, said copolymer comprises a 50:50 mixture of C₁₂ H₂₅ and C₁₈ H₃₇ substantially straight chain hydrocarbon.

According to a third aspect of the present invention, there is provided a polymer blend comprising a first copolymer and a second copolymer, said first copolymer comprising repeating units being represented by general formula (1) and (2):

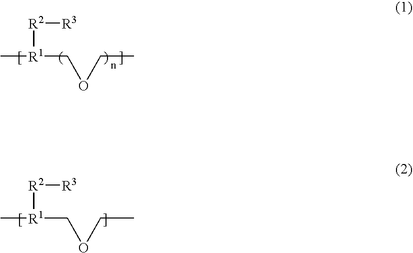

where R¹ is alkylene or a benzene nucleus; R² is oxygen, nitrogen, alkylene, phenylene or CH₂; R³ is alkyl, phenyl or alkyl-phenyl and 8≧n≧2, preferably n is 5; and said second copolymer comprising repeating units being represented by general formula (3):

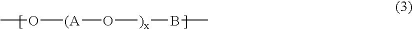

where A is alkylene or phenylene; B is alkylene, phenylene, alkylene ether, phenylene ether, alkylene-phenylene ether, alkoxy-phenylene ether or alkyl-phenylene ether; 40≧x≧20.

According to specific implementations of compound (3) the alkoxy or alkyl component may comprise —(CH₂)ₘ—H where 30≧m≧5, more preferably m is 12, 16 or 18.

Preferably, R¹ is a benzene nucleus; R² is oxygen and R³ is a substantially straight chain hydrocarbon preferably —(CH₂)ₘ—H where 30≧m≧5, more preferably m is 12, 16 or 18; A is (CH₂)₄; B is a substantially straight chain hydrocarbon preferably (CH₂)ₘ or B is —O—C₆H₄—O—(CH₂)₁₂—O—C₆H₄—O—.

Preferably, R¹ is CH, R² is oxygen and R³ is a substantially straight chain hydrocarbon preferably —(CH₂)ₘ—H where 30≧m≧5, more preferably m is 12, 16 or 18; A is (CH₂)₄; B is a substantially straight chain hydrocarbon preferably (CH₂)ₘ or B is —O—C₆H₄—O—(CH₂)₁₂—O—C₆H₄—O—.

According to a fourth aspect of the present invention, there is provided a polymer electrolyte being configured to provide ion transport, said polymer electrolyte comprising: a main-chain polyether repeating unit being configured to provide ion transport; an alkylene group or a benzene nucleus being interdispersed within said polyether repeating unit; a hydrocarbon side-chain extending from said alkylene group or said benzene nucleus, said hydrocarbon side-chain being configured to interdigitate with hydrocarbon side-chains of neighbouring polyether repeating units; said polymer electrolyte characterised in that: said main-chain polyether repeating unit comprises a single methylene-oxy-methylene linkage; wherein ion transport may be provided within a coordinating channel formed by said repeating unit.

Preferably, said hydrocarbon side-chain is alkyl, phenyl or a substantially straight chain hydrocarbon preferably —(CH₂)ₘ—H where 30≧m≧5, more preferably m is 12, 16 or 18.

Preferably, said hydrocarbon side-chain is provided on each alkylene group or benzene nucleus within a plurality of repeating units.

Preferably, said hydrocarbon side-chain extends from some of the alkylene groups or benzene nuclei of a plurality of repeating units.

Preferably, said polymer electrolyte is arranged as a lattice, said lattice comprising ionophilic regions of polyether repeating units and ionophobic regions of hydrocarbon side-chains.

According to a fifth aspect of the present invention, there is provided a polymer comprising a repeating unit being represented by general formula (2):

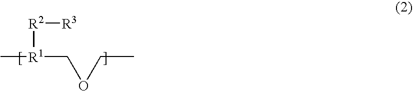

where R¹ is alkylene or a benzene nucleus; R² is oxygen or nitrogen, alkylene, phenylene or CH₂; R³ is alkyl, phenyl, alkyl-phenyl or hydrogen.

Preferably, R¹ is a benzene nucleus, R² is oxygen and R³ is a substantially straight chain hydrocarbon preferably —(CH₂)ₘ—H where 30≧m≧5, more preferably m is 12, 16 or 18.

Preferably, R¹ is CH, R² is oxygen and R³ is a substantially straight chain hydrocarbon preferably —(CH₂)ₘ—H where 30≧m≧5, more preferably m is 12, 16 or 18.

Preferably, R¹ is CH or a benzene nucleus, R² is CH₂ and R³ is a substantially straight chain hydrocarbon preferably —(CH₂)ₘ—H where 30≧m≧5, more preferably m is 12, 16 or 18.

According to a sixth aspect of the present invention, there is provided a polymer electrolyte being configured to provide ion transport, said polymer electrolyte comprising: an ion conducting polymer being represented by general formula (2):

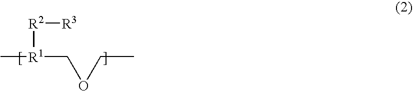

where R¹ is alkylene or a benzene nucleus; R² is oxygen, nitrogen, alkylene, phenylene or CH₂; R³ is alkyl, phenyl or alkyl-phenyl; and an ionic bridge polymer being represented by general formula (3):

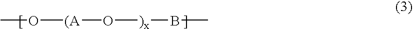

where A is alkylene or phenylene; B is alkylene, phenylene, alkylene ether, phenylene ether, alkylene-phenylene ether, alkoxy-phenylene ether or alkyl-phenylene ether;; 40≧x≧20.

Preferably, R¹ is a benzene nucleus; R² is oxygen and R³ is a substantially straight chain hydrocarbon preferably —(CH₂)ₘ—H where 30≧m≧5, more preferably m is 12, 16 or 18; A is (CH₂)₄; B is a substantially straight chain hydrocarbon preferably (CH₂)ₘ or B is —O—C₆H₄—O—(CH₂)₁₂—O—C₆H₄—O—.

Preferably, R¹ is CH, R² is oxygen and R³ is a substantially straight chain hydrocarbon preferably —(CH₂)ₘ—H where 30≧m≧5, more preferably m is 12, 16 or 18; A is (CH₂)₄; B is a substantially straight chain hydrocarbon preferably (CH₂)ₘ or B is —O—C₆H₄—O—(CH₂)₁₂—O—C₆H₄—O.

According to a specific implementation of the present invention, a galvanic cell is provided comprising the polymer electrolyte/polymer blend as detailed herein, in particular the galvanic cell is configured for use with lithium cations. Optionally, the galvanic cell may be solvent free where electrolyte-decoupled ion transport occurs via ionophilic repeating unit channels between a cathode and anode.

According to a seventh aspect of the present invention, there is provided a galvanic cell comprising a polymer electrolyte being formed from a first copolymer comprising repeating units being represented by general formula (4) and (5):

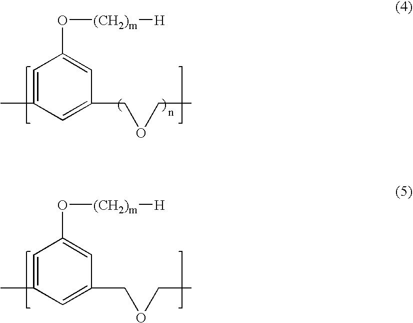

where 30≧m≧5 and 8≧n≧9, preferably m is 12, 16 or 18 and n is 5; and a second copolymer comprising repeating units being represented by general formula (3):

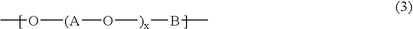

where A is alkylene or phenylene, preferably (CH₂)₄; B is alkylene, phenylene, alkylene ether, phenylene ether, alkylene-phenylene ether, alkoxy-phenylene ether or alkyl-phenylene ether;, preferably a substantially straight chain hydrocarbon, preferably (CH₂)ₘ where 30≧m≧5 or B is —O—C₆H₄—O—(CH₂)₁₂—C₆H₄—O—; 40≧x≧20.

Preferably, the galvanic cell, comprising an electrolyte, further comprises a lithium salt being represented by general formula (6):
Li X (6)

where X is ClO₄⁻, BF₄⁻ CF₃SO₃⁻ and/or (CF₃SO₂)N⁻; wherein said electrolyte is operable with conductivities in the range 10⁻⁴ to 10⁻² at ambient temperature.

According to an eighth aspect of the present invention, there is provided a process for the preparation of a polymer being represented by general formula (1):

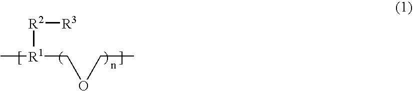

where R¹ is alkylene or a benzene nucleus, R² is oxygen, alkylene, phenylene or CH₂; R³ is alkyl, phenyl, a substantially straight chain hydrocarbon preferably —(CH₂)ₘ—H where 30≧m≧5, more preferably m is 12, 16 or 18; 8≧n≧2, preferably n is 5; said process comprising the steps of:

(a) reacting a compound being represented by general formula (7):

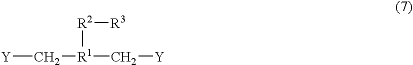

where Y is a halogen, preferably Br or Cl; with a compound being represented by general formula (8):

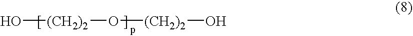

where 7≧p≧1, preferably p is 3.

Preferably, the process further comprises a step of:

(b) reacting said compound of general formula (7) and general formula (8) with a compound being represented by general formula (9):

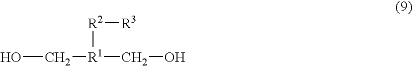

Preferably, compounds (7) and (8) are reacted in a DMSO solvent or a solvent mixture of DMSO: THF.

According to a ninth aspect of the present invention, there is provided a process for the preparation of a copolymer, said copolymer comprising repeating units being represented by general formula (1) and (2):

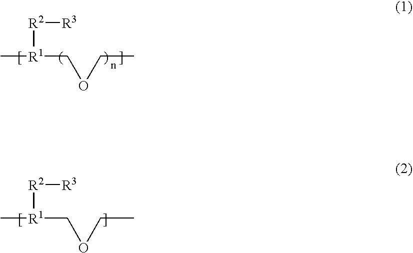

where R¹ is alkylene or a benzene nucleus; R² is oxygen, alkylene, phenylene or CH₂; R³ is alkyl, phenyl or a substantially straight chain hydrocarbon, preferably —(CH₂)ₘ—H where 30≧m≧5, more preferably m is 12, 16 or 18; 8≧n≧2, preferably n is 5; said process comprising the steps of:

(a) reacting a compound being represented by the general formula (7):

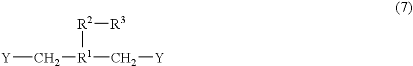

where Y is a halogen, preferably Cl or Br; with a compound being represented by general formula (8):

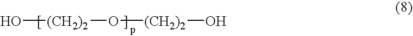

where 7≧p≧1, preferably p is 3.

(b) reacting said compound of general formula (7) and general formula (8) with a compound being represented by general formula (9):

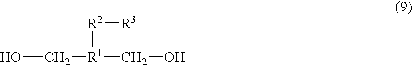

According to a tenth aspect of the present invention, there is provided a process for the preparation of a compound being represented by the general formula (2):

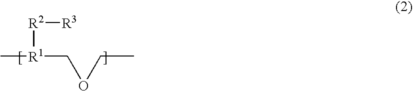

where R¹ is alkylene or a benzene nucleus; R² is oxygen, alkylene, phenylene or CH₂; R³ is alkyl or phenyl, a substantially straight chain hydrocarbon, preferably —(CH₂)ₘ—H where 30≧m≧5, more preferably m is 12, 16 or 18; the process comprising the steps of:

(a) reacting a compound of general formula (7):

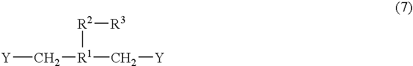

where R¹ is alkylene or a benzene nucleus, R² is oxygen, alkylene, phenylene or CH₂; R³ is alkyl, phenyl, or a substantially straight chain hydrocarbon, preferably —(CH₂)ₘ—H where 30≧m≧5, more preferably m is 12, 16 or 18; said process comprising the steps of: with a compound being represented by general formula (9):

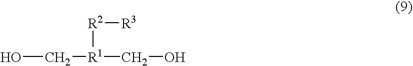

According to an eleventh aspect of the present invention, there is provided a process for the preparation of a polymer electrolyte comprising the steps of:

(a) forming an ion conducting polymeric material having repeating units being represented by general formula (2):

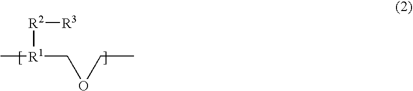

where R¹ is alkylene or a benzene nucleus; R² is oxygen, alkylene, phenylene or CH₂; R³ is alkyl, phenyl, or a substantially straight chain hydrocarbon, preferably —(CH₂)ₘ—H where 30≧m≧5, more preferably m is 12, 16 or 18;

(b) heating said polymer electrolyte above a transition temperature.

Preferably, the process further comprises the steps of:

(c) prior to said heating step (b) blending compound (2) with a compound being represented by general formula (1):

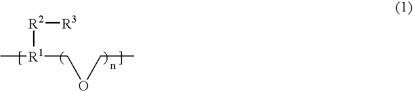

8≧n≧9, preferably n is 5.

Preferably, the process further comprises the step of:

(d) prior to said heating step (b) blending compound (2) with an ionic bridge polymer, said ionic bridge polymer being represented by general formula (3):

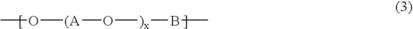

where A is alkylene or phenylene, preferably (CH₂)₄; B is alkylene, phenylene, alkylene ether, phenylene ether, alkylene-phenylene ether, alkoxy-phenylene ether or alkyl-phenylene ether;, preferably a substantially straight chain hydrocarbon, preferably (CH₂)ₘ where 30≧m≧5 or B is —O—C₆H₄—O—(CH₂)₁₂—O—C₆H₄—O—; 40≧x≧20.

Preferably, the process further comprises the step of:

(e) prior to said heating step (b) blending compound (2) and compound (1) with an ionic bridge polymer, said ionic polymer being represented by general formula (3):

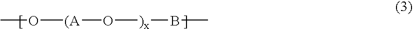

where A is alkylene or phenylene, preferably (CH₂)₄; B is alkylene, phenylene, alkylene ether, phenylene ether, alkylene-phenylene ether, alkoxy-phenylene ether or alkyl-phenylene ether;, preferably a substantially straight chain hydrocarbon, preferably (CH₂)ₘ where 30≧m≧5 or B is —O—C₆H₄—O—(CH₂)₁₂—O—C₆H₄—O—; 40≧x≧20.

Preferably, said transition temperature is above a melting or glass transition temperature of compound (1).

Preferably, said transition temperature is between ambient and 110° C.

Preferably, following said heating step (b) said polymer electrolyte comprises a lamellar, micellar or lamellar-micellar complex morphology.

Preferably, said second ionic bridge polymer is represented by the general formula (10):

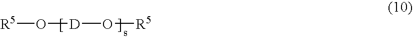

where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧0.

According to a specific implementation of the present invention the second ionic bridge polymer may be bonded to at least one end of the ion conducting polymer. For example, R⁵ of general formula (10) may be replaced with the repeating unit, being represented by general formula (2). Accordingly, the second ionic bridge polymer is maintained at the interface between the amphiphilic ion coordinating regions and the interdispersed first ionic bridge polymer.

Accordingly enhanced conductivity of the polymer electrolyte may be associated with the ionic bridge-ion conducting polymer hybrid species due to the even distribution of the second ionic bridge polymer at the interface with the first ionic bridge polymer. The bonding of the second ionic bridge polymer to the end units of the ion coordinating regions or channels may avoid a requirement to incorporate the separate and mobile second ionic bridge polymer in combination with the first ionic bridge polymer.

A possible synthetic route for the preparation of the above second ionic bridge polymer—ion conducting polymer hybrid species involves the preparation of the ion conducting polymer followed by introduction of the second ionic bridge polymer within a suitable solvent medium. The second ionic bridge polymer is therefore “tagged” onto the end of the ion conducting polymer following the polymerisation of the ion conducting polymer.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically an organised, de-blended electrolyte complex;

FIG. 2 illustrates schematically an ion conducting channel within the electrolyte complex;

FIG. 3 illustrates schematically the electrolyte complex arranged as a lamellar texture;

FIG. 4 is a log conductivity vs 1/T plot for an electrolyte system according to a specific implementation of the present invention;

FIG. 5 is a log conductivity vs 1/T plot for an electrolyte system according to a specific implementation of the present invention;

### DETAILED DESCRIPTION OF A SPECIFIC MODE FOR CARRYING OUT THE INVENTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

Within this specification the repeating units of the ion conducting polymer are represented by PO1-sc in the case of a main-chain second repeating unit comprising secondary ion coordinating sites and PO5-sc for a main-chain first repeating unit comprising primary ion coordinating sites. According to specific implementations of the present invention PO1-sc involves a single alkylene oxide repeating unit optionally in addition to a hydrocarbon side-chain extending from the main-chain and PO5-sc comprises five alkylene oxide repeating units optionally in addition to a hydrocarbon side-chain. This nomenclature does in no way restrict the present invention to utilisation of an ion conducting polymer comprising specifically one or five alkylene oxide repeating units within the main-chain. As will be appreciated by those skilled in the art, the present invention may include any number of alkylene oxide repeating units (single or plurality) forming part of the main-chain, in accordance with the teachings of the present invention.

Additionally, within this specification a first ionic bridge polymer is represented by 1 BP and a second ionic bridge polymer is represented by 2 BP.

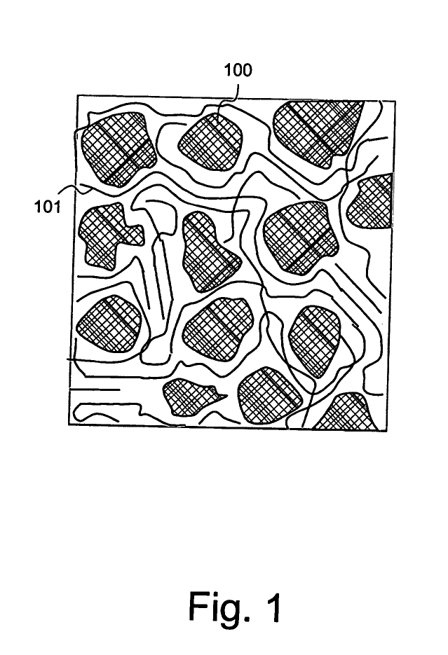

Referring to FIG. 1 herein there is illustrated a schematic view of the polymer electrolyte comprising an ion conducting polymer 100 and a first ionic bridge polymer 101, exhibiting an ordered morphology.

Following a de-blending process, described below, the electrolyte system adopts a well-defined morphology where the ion conducting polymer is arranged in discreet lamellar or micellar regions, ion transport within such regions being provided by the amphiphilic main-chain first and second repeating units, PO5-sc and PO1-sc, respectively. Ionic bridge polymer 101 (1 BP or 2 BP) provides a binding function being interdispersed between the micellar or lamellar regions. Ion transport therefore occurs between regions 100 and 101 where, for example, the electrolyte complex is provided between electrodes of a battery.

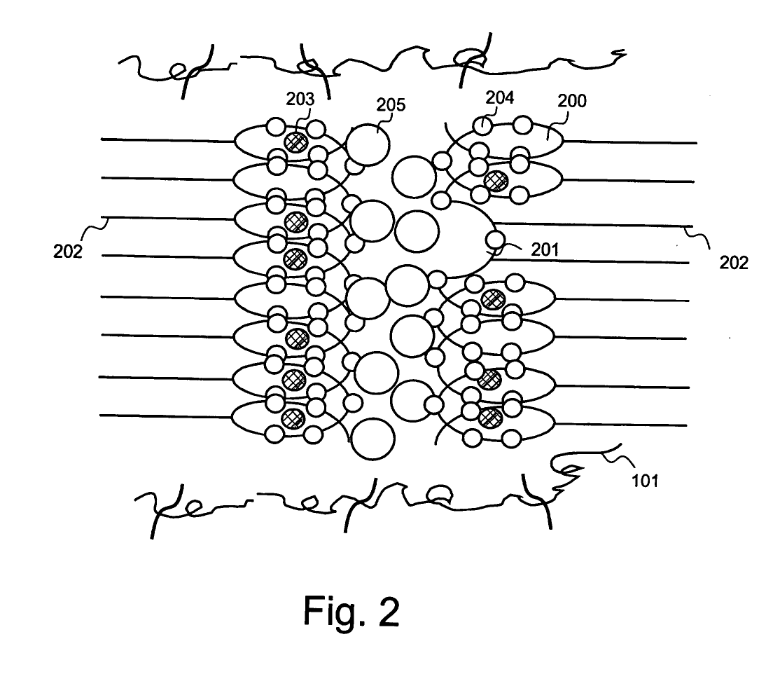

Referring to FIG. 2 herein there is illustrated a schematic view of a coordinating channel of the electrolyte system as detailed with reference to FIG. 1 herein comprising PO5-sc repeating units 200; PO1-sc repeating units 201; hydrocarbon side-chain repeating units 202; metal ions 203; coordinating atoms 204 and complex anions 205.

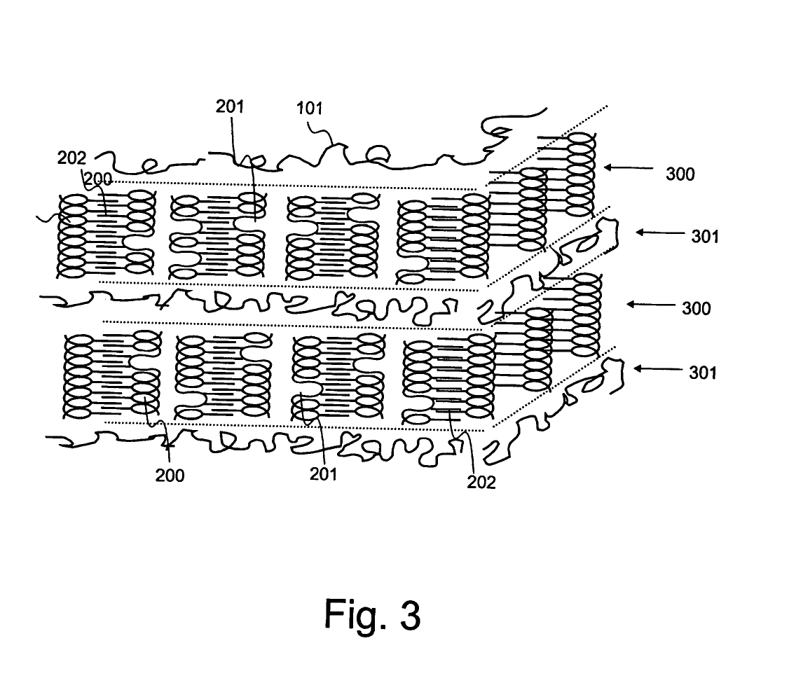

Following the de-blending process, described below, the electrolyte system adopts a well-defined morphology being arranged into ionophobic repeating unit regions involving an interdigitation of side-chains 202 as detailed with reference to FIG. 3 herein, and ionophilic repeating unit regions or channels resulting from the organisation of main-chain first and second repeating units 200, 201. According to the specific implementation of the present invention the PO5-sc repeating units 200 are arranged as a substantially helical ion coordinating channel 200, the PO1-sc repeating units 201 being interdispersed between this helical structure.

Accordingly, the main-chain ion conducting polymer backbone comprised ‘spaces’ or ‘voids’ 201 as detailed with reference to FIG. 2 herein wherein metal ion transport 203 is enhanced within the ionophilic coordinating channel. By allowing the anions a degree of motional freedom due to the breaks 201 within channel 200, enhanced ion transport is achieved ultimately providing enhanced conductivity. A cation ‘jump’ motion promoted by local anion mobility may be envisaged within the coordinating channel. Accordingly, an electrolyte complex is provided allowing de-coupled ion motion within a plurality of coordinating channels formed from oxygen-rich primary ion coordinating sites 200 being interdispersed with oxygen-deficient secondary ion coordinating sites 201.

1 BP 101 acts as an ionic bridge or ‘glue’ between lamellar or micellar regions. According to specific implementations of the present invention a second ionic bridge polymer 2 BP 206 is provided, acting as an interface between ion conducting polymer regions 100 and ionic bridge 101. Incorporation of 2 BP increases the observed conductivity in addition to weakening the temperature dependence of conductivity.

Due to a relative motional freedom enjoyed by 1 BP and/or 2 BP within the electrolyte system, on cooling the electrolyte an otherwise observed decrease in ion conductivity due to shrinkage and/or a freezing of the hydrocarbon ionophobic regions is offset by the ‘glue’-like effect of the interdispersed 1 BP and/or 2 BP serving as an ionic bridge. Ion conductivity is therefore not substantially decreased following a decrease in temperature on passing through the melting and/or glass transition temperature of the interdigitated side-chains.

Referring to FIG. 3 herein there is illustrated a schematic view of the electrolyte complex as detailed with reference to FIG. 2 herein comprising a lamellar morphology the lamellar layers of ion conducting polymer 300 being separated by layers of 1 BP 301.

As will be appreciated by those skilled in the art, following the de-blending process detailed below, interdigitation of the ionophobic hydrocarbon side-chains 202 and interaction between the metal salt and the ionophilic main-chain repeating units PO1-sc and PO5-sc provides an organised lamellar morphology. Incorporation of 2 BP within the complex, may to serve to facilitate regular termination of the main-chains in turn promoting aggregation and a possible micellar morphology.

The polymer electrolyte according to the present invention, within a battery, provides for enhanced conductivity due to ion coordination within the coordinating channels resulting from ion oxygen-rich, ion oxygen-deficient coordination of the polyalkylene oxide repeating units.

According to a second embodiment of the present invention ion transference is provided via ion coordinating channels comprising PO1-sc without incorporation or substantial incorporation of PO5-sc. A polymer electrolyte comprising a main-chain backbone of PO1-sc may provide mechanical advantages resulting from the increased chain rigidity. Electrolyte films of increased durability may therefore be provided in turn providing a more compact lightweight battery.

According to the second specific embodiment of the present invention 1BP and/or 2BP are utilised to maintain conductivity at ambient and reduced temperatures, such ionic bridge polymers serving to offset any temperature dependent conductivity effect on passing through the hydrocarbon side-chain melting and/or glass transition temperature(s).

There will now be described specific examples according to certain aspects of the present invention.

PO1-sc may be represented by specific formula (I):

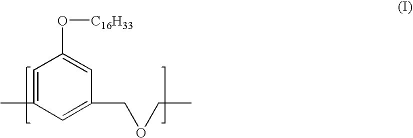

PO5-sc may be represented by specific formula (II):

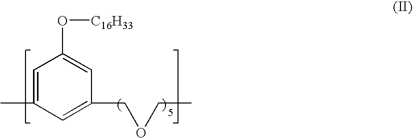

1 BP may be represented by specific formula (III):

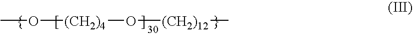

2BP may be represented by specific formula (IV)

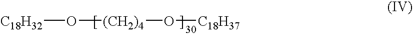

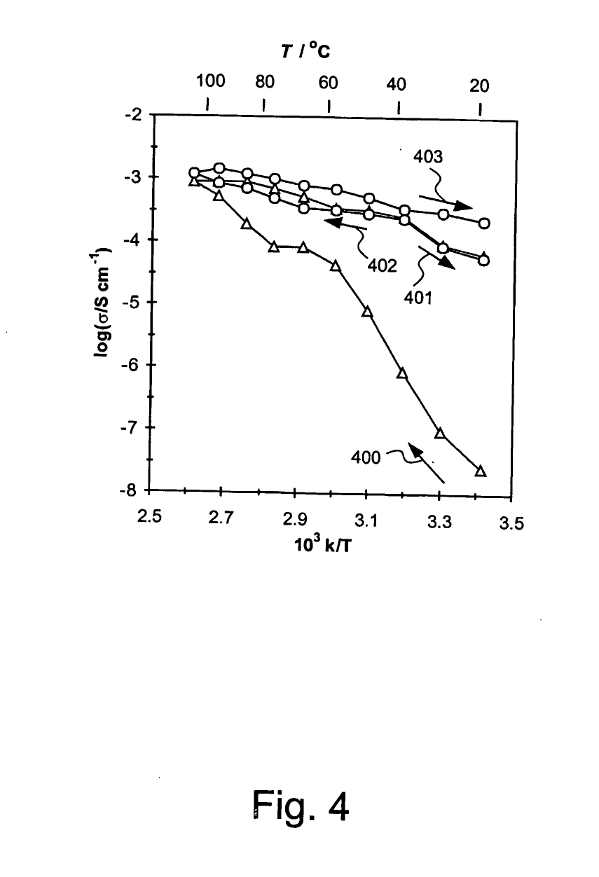

Referring to FIG. 4 herein there is illustrated AC conductivities measured by complex impedance spectroscopy as a log σ vs 1/T plot for the electrolyte system comprising the ion conducting polymer formed as a copolymer of compound (I) and (II): compound (III): LiBF₄ in molar ratios (1:1:1.2). During an initial heating (de-blending process) up to ca. 100° C. the conductivity rose steeply 400. On cooling 401 the conductivity remained high down to ambient temperature where following a second heating cycle 402 and cooling cycle 403, the conductivities remained high exhibiting reduced temperature dependence of the first heating cycle. Accordingly, conductivities within the range 10⁻² to 10⁻⁴ S cm⁻¹ have been observed with this system.

Enhanced ion conductivity is provided along the ionophilic main-chain polymer backbone due to the creation of ‘spaces’ within the main-chain backbone involving the copolymer of compounds (I) and (II) as detailed with reference to FIG. 2 herein. Interdigitation of the C₁₆H₃₃ hydrocarbon side-chains provides a well-defined electrolyte morphology allowing substantially de-coupled ion mobility notwithstanding minor local conformational motions of the polyether main-chains.

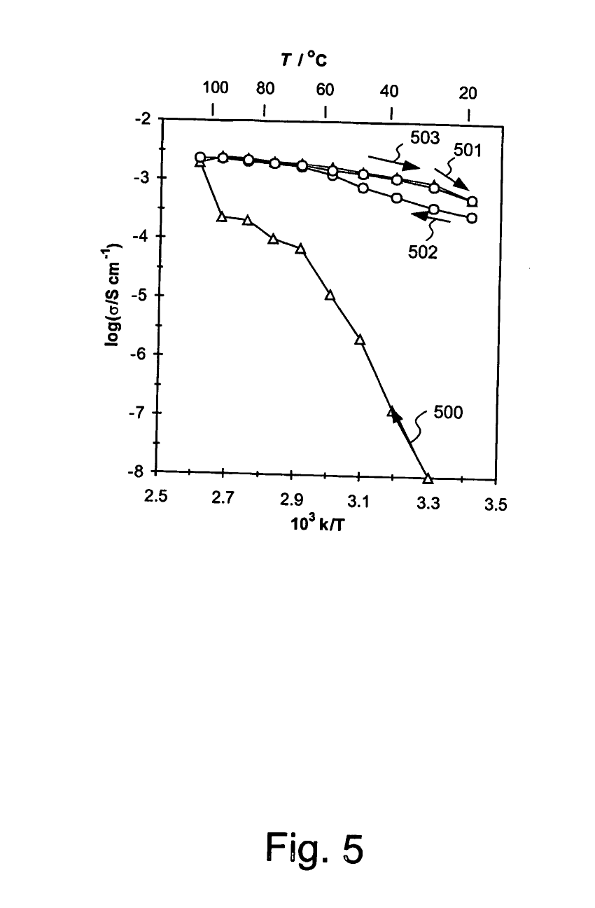

Referring to FIG. 5 there is illustrated AC conductivities measured by complex impedance spectroscopy as a log a vs 1/T plot for the ion conducting polymer formed as a copolymer of compounds (I) and (II): compound (III): compound (IV): LiBF₄ in molar ratios (1:0.8:0.2:1.2). As observed with reference to FIG. 4 herein following a first initial heating 500, consistently high conductivities are maintained during and following a first cooling cycle 501, a second heating cycle 502 and subsequent cooling cycle 503. Due to the incorporation of the ‘surfactant’ compound (IV), elevated AC conductivities are observed for this system as compared with the system of FIG. 4 herein.

According to specific implementations of the present invention as a weight fraction the electrolyte system comprises 1 BP or 1 BP/2 BP present as ≦ca. 50%.

Referring to FIGS. 4 and 5 herein the de-blending process establishing the lamellar or micellar morphologies is onset by initial heating cycle 400, 500, the established morphology being maintained through the first and successive cooling cycles providing in turn enhanced electrolyte ion conductivities having reduced temperature-dependent characteristics.

DC polarisation measurements using lithium electrodes gave ambient conductivities in the range 10⁻³ to 10⁻² S cm⁻¹ in good accord with AC impedance measurements. Such DC conductivities thereby implying Li⁺ transport between electrodes. Moreover, conductivities of the order 10⁻² S cm⁻¹ were observed at ambient temperature; such conductivities being established and maintained following an initial “electrolyte-ordering”.

There will now be described specific preparations and examples to illustrate specific aspects of the present invention.

### GENERAL PREPARATION PROCEDURE FOR COPOLYMER (I) AND (II) [EXAMPLE 1]

The copolymer of compound (I) and (II) was prepared in dry DMSO: THF co-solvent. By adjusting the relative proportions of DMSO to THF a tunable synthetic procedure is provided whereby a desired amount of main-chain first repeating units (compound (II)) and main-chain second repeating units (compound (I)) are incorporated within the main-chain polymer backbone. Accordingly, the aforementioned substantially helical ion coordinating channel is formed from compound (II) being interdispersed with ion coordinating ‘spaces’ resulting from incorporation of compound (I). In particular, increasing the amount of DMSO (being a substantially polar solvent) has the effect of increasing aggregation of the hydrocarbon side-chains thereby promoting synthesis of an ion conducting polymer being compound (I) rich. Conversely, if the molar concentration of THF is increased, aggregation of the hydrocarbon side-chains is less and an ion conducting polymer having enhanced main-chain second repeating unit content (compound (II)) may be obtained.

### GENERAL PREPARATION PROCEDURE FOR COPOLYMER (I) AND (II) [EXAMPLE 2]

Copolymers of compound (I) and compound (II) mixed polyether skeletal sequences were obtained from reactions involving appropriate molar proportions of the three types of monomer 5-alkyloxy-1,3-bis(bromomethyl)benzene, 5-alkyloxybenzene-1,3-dimethanol and tetraethylene glycol. For copolymers with greater proportions of compound (I) units a proportion of tetraethylene glycol was replaced by the alkyloxybenzene-1,3-dimethanol. However, the relative monomer proportions were determined by solubility considerations rather than stoichiometry owing to the amphiphilic nature of the side chain bearing monomers and the polymer product. The reaction also involved dehydration condensation between benzylic hydroxyls as well as the Williamson type condensations between hydroxyls and halogen functionalities.

Copolymers with mixed alkyl side chains were readily prepared by mixing the appropriate side chain bearing monomers in the desired molar proportion. In this case the molar proportions in the monomer mixture are apparently reproduced in the polymer product in which they are presumably in random sequence.

### Synthesis of 5-hydroxybenzene-1,3-dicarboxylic acid diethyl ester

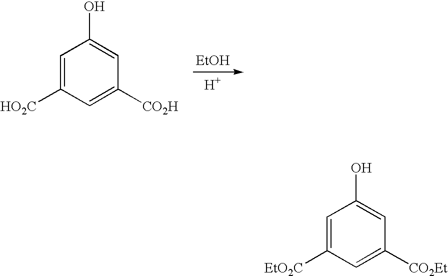

36.5 g (0.2 mol) 5-hydroxyisophthalic acid, 150 ml ethanol and 2 ml concentrated sulphuric acid were refluxed for 3 hrs. The ethanol was removed under vacuum and the white crystals were washed with water and then dissolved in 200 ml ethyl acetate. The solution was washed sequentially with aqueous sodium bicarbonate solution and water and finally dried over magnesium sulphate. After concentrating the solution under vacuum, white needles separated. The yield of 5-hydroxybenzene-1,3-dicarboxylic acid diethyl ester, m.p. 106° C., was 43.4 g (91%). IR: 3291.4, 2985, 2907, 1804-1700, 1400-1250 cm⁻¹.

### Synthesis of 5-hexadecyloxybenzene-1,3-dicarboxylic acid diethyl ester

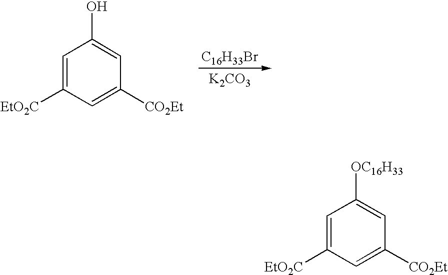

16.5 g (0.069 mol) 5-hydroxybenzene-1,3-dicarboxylic acid diethyl ester, 21 g (0.069 mol) 1-bromohexadecane and 120 ml acetone were refluxed in the presence of 11.9 g (0.086 mol) potassium carbonate for 24 hrs. After addition of 100 ml water, the solution was extracted with pentane. The pentane solution was washed with aqueous potassium hydroxide solution, water and then dried over magnesium sulphate. The solvent was evaporated under reduced pressure. The yield of 5-hexadecyloxybenzene-1,3-dicarboxylic acid diethyl ester, m.p.45° C., was 24 g (75%). IR: 3042, 2935, 1724, 1608, 1501, 1475 and 1251 cm⁻¹.

### Synthesis of 5-hexadecyloxybenzene-1,3-dimethanol

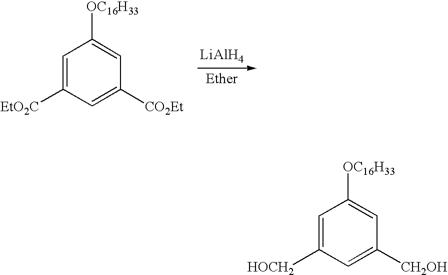

15 g (0.0325 mol) 5-hexadecyloxybenzene-1,3-dicarboxylic acid diethyl ester was reduced using 3.1 g (0.082 mol) lithium aluminium hydride by refluxing in ethyl ether for 4 hrs. Ethyl acetate was added into the solution to decompose the remaining lithium aluminium hydride. The solution was poured into cooled 20% sulphuric acid. The mixture was extracted with chloroform. After drying over magnesium sulphate, the extract was evaporated under reduced pressure. The crude product was recrystallized from dichloromethane to afford white crystals. The yield of 5-hexadecyloxy benzene-1,3-dimethanol, m.p.90° C., was 10 g (81%). IR: 3256, 3060, 2917, 1600, 1472, 1150 and 1031 cm⁻¹. Elemental analysis, required: (%) C (76.19), H(11.11); found: (%) C (76.07), H (11.40).

¹HNMR(CDCl₃) δ 0.85 (t, 3H), 1.25 (s 24H), 1.45 (5 peaks, 2H), 1.75 (5 peaks, 2H), 3.9 (t 2H), 4.65 ( d, 4H), 6.85 (s, 2H), 6.95 (s, 1H).

### Synthesis of 5-hexadecyloxy-1,3-bis(bromomethyl)benzene

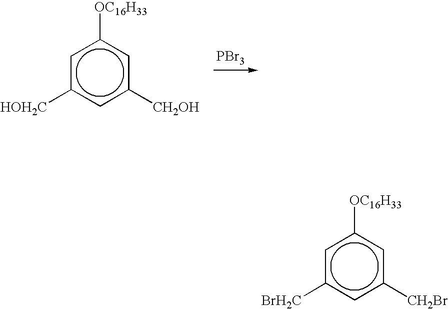

5 g of 5-hexadecyloxybenzene-1,3-dimethanol was suspended in 20 ml dry ethyl ether and stirred under a dry atmosphere and cooled down to 0° C. Into the suspension, 3.18 g of phosphorous tribromide was added drop-wise, while keeping the temperature of the mixture below 5° C. After completion of the addition, the solution was allowed to warm up to room temperature and stirred for 10 hrs. The reaction mixture was then poured into a crushed ice bath, the separated organic layer was washed with a 10% sodium carbonate in water solution. The product was dried over anhydrous potassium carbonate and the solvents evaporated to yield white crystals. ¹H NMR(CDCl₃)δ: 0.85 (t, 3H), 1.25 (s, 28H), 1.45 (5 peaks, 2H), 1.75 (5 peaks, 2H), 3.95 (t, 2H), 4.40 (s, 4H), 6.85 (s, 2H). 6.95 (s,1 H). Elemental analysis: Br, required 31.68%, found 31.49%.

### Synthesis of Polymer compound (II)

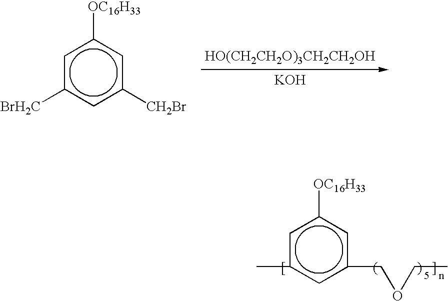

Compound (II), was prepared by heating with gentle stirring at 3˜50° C. of 1 g (0.002 mol) 5-hexadecyloxy-1,3-bis(bromomethyl)benzene, 0.385 g (0.002 mol) tetraethylene glycol, and 0.44 g (0.008 mol) potassium hydroxide in 1 ml dimethyl sulphoxide and 1 ml THF for 3 hours. The polymer was precipitated in water. The mixture was neutralized with concentrated acetic acid. The polymer was separated and washed with hot water 3 times to remove inorganic salt and finally with hot methanol 3 times to remove monomer. ¹H NMR(CDCl₃) δ: 0.85 (t, 3H), 1.25 (s, 28H), 1.75 (5 peaks, 2H), 3.65 (d, 15H), 3.95 (t, 2H), 4.50 (s, 4H), 6.80 (d, 3H). Hot stage microscopy indicates that the polymer melts at 27° C. The FTIR spectrum shows that the peak of OH group (3256 cm⁻¹) is not present.

### SYNTHESIS OF COPOLYMER (I) [EXAMPLE 1]

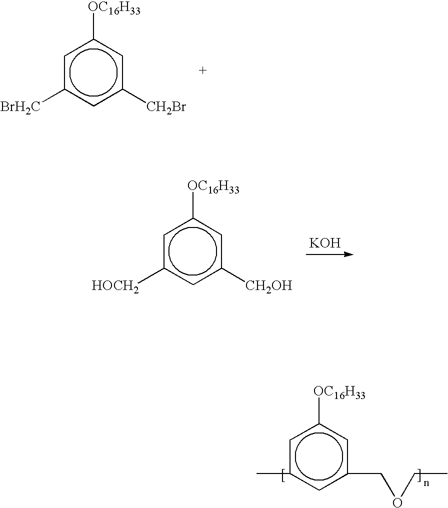

Compound (I), was prepared by heating with gentle stirring at 60° C. of 1 g (0.002 mol) 5-hexadecyloxy-1,3-bis(bromomethyl)benzene, 0.75 g (0.002 mol) 5-hexadecyloxybenzene-1,3-dimethanol, and 0.44 g (0.008 mol) potassium hydroxide in 1 ml dimethyl sulphoxide and 1 ml THF for 3 days. The polymer was precipitated in water. The mixture was neutralized with concentrated acetic acid. The polymer was separated and washed with hot water 3 times to remove inorganic salt and finally with hot methanol 3 times to remove monomer. ¹H NMR(CDCl₃) δ: 0.85 (t, 3H), 1.25 (s, 27H), 1.45 (5 peaks, 2H), 1.75 (5 peaks, 2H), 3.95 (t, 2H), 4.50 (s, 4H), 6.85 (d, 3H). Tₘ=42° C. (hot stage optical microscopy). The FTIR spectrum shows that the OH peak (3256 cm⁻¹) is not present.

### SYNTHESIS OF COPOLYMER (I) AND (II) [SPECIFIC EXAMPLE 1]

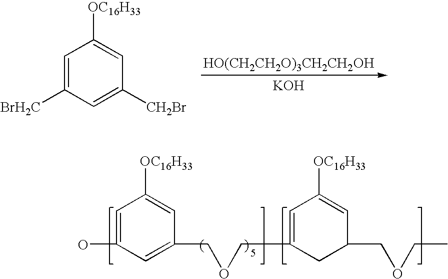

The copolymer of compound (I)-(II), was prepared by heating with gentle stirring at 60° C. of 1 g (0.002 mol) 5-hexadecyloxy-1,3-bis(bromomethyl)benzene, 0.385 g (0.002 mol) tetraethylene glycol, and 0.88 g (0.016 mol) potassium hydroxide in 2 ml dimethyl sulphoxide for 20 min. The polymer was precipitated in water. The mixture was neutralized with concentrated acetic acid. The polymer was separated and washed with hot water 3 times to remove inorganic salt and finally with hot methanol 3 times to remove monomer. ¹H NMR(CDCl₃) δ: 0.85 (t, 3H), 1.25 (s, 28H), 1.45 (5 peaks, 2H), 1.75 (5 peaks, 2H), 3.60 (2 main peaks, 10.6H), 3.95 (t, 1.6H), 4.50 (s, 3.3H), 6.80 (d, 2.7H). The GPC gave molar mass averages, M_{w}=70.5×10³, M_{z}=4.9×10⁶. Hot stage microscopy indicates that the polymer melts at 28° C. The FTIR spectrum shows that the peak of OH group (3256 cm⁻¹) is not present. The ratio [ethoxy hydrogens(δ 3.60)]/[aromatic hydrogens(δ 6.8)]=(3/2.7)×(10.6/16)=0.74 indicates 26% of compound (I) units in the copolymer.

### SYNTHESIS OF COPOLYMER (I) AND (II) VARIANT [SPECIFIC EXAMPLE 2]

In the following example both types of copolymerisation skeletal chain and side chain-were combined to give a copolymer of compound (I) and (II) having 50/50 molar mixture of —C₁₂H₂₅ and —C₁₈H₃₇ side chains and replacing the C₁₆ H₃₃ side chains of compounds (I) and (II). The different repeating units were mixed to give a copolymer comprising 78 mol % of the compound (I) variant and 22 mol % of the compound (II) variant.

A mixture of 0.593 g (0.0011 mol) 5-octadecyloxy-1,3-bis(bromomethyl)benzene, 0.5 g (0.0011 mol) 5-dodecyloxy-1,3-bis(bromomethyl)benzene, 0.090 g (0.0011 mol) 5-octadecyloxybenzene-1,3-dimethanol, 0.113 g (0.0011 mol) 5-dodecyloxybenzene-1,3-dimethanol, 0.325 g (0.0017 mol) tetraethyleneglycol 0.30 g (0.0044 mol) of potassium hydroxide (15%hydrated) was dissolved and heated with stirring at 65° C. in dimethylsulphoxide for 24 hours. The temperature was then raised to 85° C. for a further 24 hours after which a further 0.30 g (0.0044 mol) of potassium hydroxide (15%hydrated) was added and the reaction continued for 5 days. The polymer was then precipitated in water and the mixture was neutralised with concentrated acetic acid. The polymer was separated and washed with hot water 3 times to remove inorganic salts and was finally washed several times with hot methanol to remove monomers. The polymer was then dried by warming under vacuum. ¹H NMR (CDCl₃) δ: 0.85 (t, 3H); 1.25 and 1.45 (5 peaks and 5 peaks, 24.4H); 1.75 (5 peaks, 2 H); 3.60 (2 peaks, 3.6H ethoxy); 3.95 (t, 2H); 4.50 (s, 4H); 6.85 (5 peaks, 3 H aromatic). The peak at 3.6 ppm suggests that C16O5 units are present in proportion 3.6×100/16=22 mol %. The side chain peaks 0.85, 1.25, 1.45, 1.75 and 3.95 amount to 31 hydrogens corresponding to an ‘average’ pentadecyl side chain which represents 50/50 mol % mixture of C18 and C12 side chains.

Alternatively, finally divided potassium hydroxide may be added in large excess (1000%).

### Synthesis of *Compound (III)

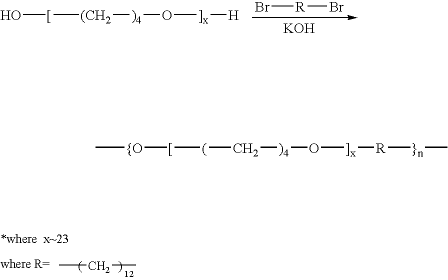

Compound (III) was prepared by standard Williamson condensation of hydroxy-terminated polytetrahydrofuran (Mₙ=1688 g mol⁻¹) with 1,12-dibromododecane and excess powdered KOH (8 molar ratio) at 90° C. *compound (III) was purified by washing with dilute aqueous acetic acid followed by water and dried under vacuum. Gel permeation chromatography showed that <M_{w}>=2.5×10⁴. IR: 2940 cm⁻¹, 2859 cm⁻¹ (CH₂ stretch) and 1113 cm⁻¹ (C—O stretch). DSC of *compound (III) indicates that the polymer melts at 24° C.

### Synthesis of *Compound (IV)

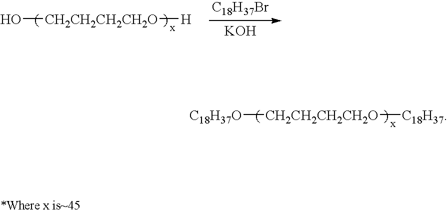

*Compound (IV) was prepared by standard Williamson condensation of 8.44 g (0.005 mol) hydroxy-terminated polytetrahydrofuran (Mₙ=1688 g mol⁻¹) with 3.33 g (0.005 mol) 1-bromododecane and excess powdered (8 molar ratio) 2.24 g KOH in 40 ml dimethyl sulphoxide for 7 days at 90° C. *Compound (IV) was purified by washing with dilute aqueous acetic acid followed by water and dried under vacuum. The GPC result gave molar mass averages Mₙ=3250; M_{w}=4724. DSC of *compound (IV) indicates that the polymer melts over the range 10-35° C. IR 3482 (νOH), shoulder 3000-2950 (ν-CH₃) 2923, 2798, 2740, (νCH₂)-1110 (νC—O)

### SYNTHESIS OF DIETHYL 2-OCTADECYL PROPANDIOATE, SYNTHESIS OF DIETHYL 2-OCTADECYL PROPANEDIOATE

After dissolving 2.3 g of Na (0.1 mole) in 250 ml anhydrous EtOH, 16 g of diethylmalonate (0.1 mole ) was added dropwise under argon. After one hour at 50° C., 33.3 g (0.1 mole) of 1-bromooctadecane was added and the mixture stirred for 15 h. The solution was concentrated to dryness and washed with hot CHCl₃. The precipitate of NaBr is filtered and the solution dried over MgSO₄. After evaporation, a yellow oil was obtained and distilled to give, 23 g of diethyl 2-octadecyl propanedioate, yield 56%, bp: 185-190° C./0.04 torr. Mp: 28° C. IR: 2918 cm⁻¹ (CH₃ stretch), 2850 cm⁻¹ (CH₂ stretch) and 1733 cm⁻¹ (C═O stretch).

Ref: M. V. D. Nguyen, M. E. Brik, B. N. Ouvrard, J. Courtieu, L. Nicolas and A. Gaudemer, Bull. Soc. Chim. Belg., 1996, 105(14), 181-3.

### Synthesis of 2-octadecyl propane-1,3-diol

23 g (0.056 mol) diethyl 2-octadecyl propanedioate was reduced using 5.4 g (0.14 mol) lithium aluminium hydride by refluxing in ethyl ether for 6 hrs. Ethyl acetate was added into the solution to decompose the extra lithium aluminium hydride. The solution was poured into cooled 20% sulphuric acid. Collect the white solid after ether was evaporated. Wash the solid with water, aqueous K₂CO₃ solution and then water. After drying in an oven, the product was extracted in dichloromethane using a soxhlet apparatus and evaporation of the solvent gave the pure white product. The yield of 2-octadecyl propane-1,3-diol, m.p.88° C., was 15 g (81%).

### Synthesis of Aliphatic Compound (II) Variant

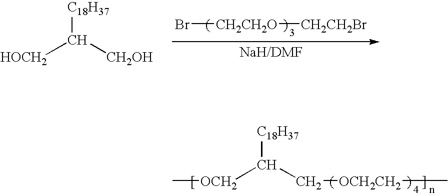

1.64 g (0.05 mol) 2-octadecyl propane-1,3-diol and 0.24 g (0.05 mol) NaH were mixed under an argon atmosphere,.and 15 ml DMF was added. The mixture was heated slowly with stirring to 90° C. over 1 hour. 1.6 g of tetraethyleneglycol dibromide in 5 ml DMF was added dropwise into the reaction and stirring was maintained at this temperature for 1 day. A second portion of 0.249 NaH was then added and stirring continued at 90° C. for a further 3 days. After the reaction mixture was cooled, water was added, followed acetic acid to neutralize the solution. The solid was separated by filtration and twice washed with water. The solid was precipitated from methanol. The aliphatic compound (II) variant, mostly melts at 45° C. ¹H NMR(400 MHz, CDCl₃): δ=0.86(t, 3H, CH₃), 1.22 (s, 34H, alkyl chain 17CH₂), 1.75 (m,1H, CH), 3.60(t, 8H, OCH₂).

### SYNTHESIS OF COMPOUND (I) [EXAMPLE 2]

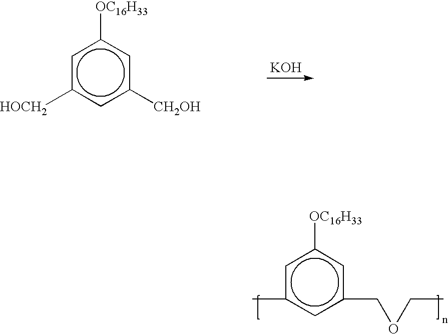

Compound (II), was prepared by heating with gentle stirring at 60° C. of 1.00 g (0.00264 mol) 5-hexadecyloxybenzene-1,3-dimethanol, and 2.24 g (0.04 mol) potassium hydroxide in 5 ml dimethyl sulphoxide for 7 days. The polymer was precipitated in water; the mixture was neutralized with concentrated acetic acid and extracted into chloroform. After evaporation of the chloroform, the residue was washed with hot water to remove inorganic salt and finally with hot methanol several times to remove the monomer. The GPC result gave molar mass averages M_{w}=10,000. DSC indicates that the polymer melts at 36° C. NMR (δ 4.5) shows only 2-3 α-hydrogens of the two —CH₂-attached to the benzene nucleus in the main chain. The FTIR spectrum shows that part of the peak of OH group disappears.

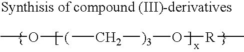

The above compound (III)-derivative may be prepared by a ring opening cationic polymerisation. The cyclic ether may be cleaved with BF₃/dietherate so as to generate the required polyalkylene oxide. Such a process may similarly be employed for other similar compound (III)-variants.

According to the compound (III)-derivatives the R group is derived from a cyclic ether whereby copolymers may be synthesised involving cyclic ether ring opening polymerisations providing in turn high molecular weight polymers (M_{w} ca 10⁵). Where the compound (III)-derivative comprises —(CH₂)₃— the cyclic ether derived R group may optionally comprise additional hydrocarbon side groups appended to the cyclic ether ring (for example methyl groups). Such side groups enhance the hydrophobic character of the polymer.

Specific examples of the compound (III)-derivative copolymers comprise: 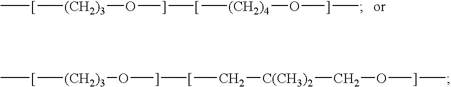
where repeating units are randomly mixed. Moreover, the ionophobic character of the resulting polymer may be selectively adjusted by varying the relative amount of the cyclic ether containing at least one side group, during polymerisation of the above compound (III)-derivatives.

Accordingly and owing to the large polymer molecular weight distributions, electrolyte systems may be provided with enhanced mechanical properties being advantageous in the manufacture of batteries.

Electrolyte Preparation

Complexes were prepared by mixing the ion conducting polymer with 1 BP and/or 2 BP together with appropriate molar proportion of Li salt, being selected from, for example, LiClO₄, LiBF₄, LiCF₃SO₃, or Li(CF₃SO₂)N, in a mixed solvent of dichloromethane/acetone. After removal of solvent with simultaneous stirring complexes were dried under vacuum at 50° C.-60° C.

An alternative preparation of the electrolytes may involve the known process of freeze-drying, following which the highly expanded polymer is collapsed as a powder and gently sintered below the de-blending temperature (ca. below 50° C.).

Cell Preparation

The Li electrodes were prepared under an atmosphere of dry argon from Li, pellets mounted in counter-sunk cavities (500 μm deep) in stainless steel strips. Cells having ITO electrodes were prepared using cellulose acetate spacers (100 μm). Complex impedance measurements and DC polarisations were performed using a Solartron (RTM) 1287A electrochemical interface in conjunction with a 1250 frequency response analyser.

Metal alloys, in particular, lithium cobalt oxides, manganese oxides or tin based alloys may also be utilised within the cell as cathodic electrodes being configured with a “binder” between particles and between electrode and electrolyte, the “binder” possibly being selected from any one or a combination of PEO, PO1-sc, PO5-sc, P-nsc, 1 BP and/or 2 BP.

1. A polymer electrolyte being configured to provide ion transport, said polymer electrolyte comprising:
a main-chain first repeating unit configured to provide a primary ion coordinating site, a plurality of main-chain repeating units being arranged as a substantially helical ion coordinating channel;
said polymer electrolyte further comprising and being characterised by:
a main-chain second repeating unit being interdispersed between said main-chain first repeating unit, said second repeating unit being configured to provide a secondary ion coordinating site within said coordinating channel, said secondary ion coordinating site being less strongly coordinating than said primary ion coordinating site;
wherein said polymer electrolyte is configured to provide ion transport within said coordinating channel involving ion transport between said primary ion coordinating site and said secondary ion coordinating site.

2. The polymer electrolyte as claimed in claim 1 wherein said main-chain first repeating unit and/or said main-chain second repeating unit comprise a hydrocarbon side-chain extending from said main-chain repeating unit, said hydrocarbon side-chain being configured to interdigitate with hydrocarbon side-chains of neighbouring main-chain repeating units.

3. The polymer electrolyte as claimed in claims 1 or 2 wherein said ion coordinating channel is oxygen-rich at said primary ion coordinating site; and
said ion coordinating channel is oxygen-deficient at said secondary ion coordinating site relative to said primary ion coordinating site.

4. The polymer electrolyte as claimed in any one of claims 1 to 3 wherein said main-chain first repeating unit comprises a plurality of methylene-oxy-methylene linkages and said main-chain second repeating unit comprises a single methylene-oxy-methylene linkage.

5. The polymer electrolyte as claimed in any one of claims 1 to 4 wherein said polymer electrolyte comprises a plurality of substantially helical ion coordinating channels being formed from a plurality of main-chain first and second repeating units arranged as a lattice by interdigitation of the hydrocarbon side-chains.

6. The polymer electrolyte as claimed in any one of claims 1 to 5 wherein ion transport within said coordinating channel is configured to be substantially decoupled from conformational motion of said main-chain first and second repeating unit.

7. The polymer electrolyte as claimed in claims 5 or 6 further comprising:
a second polymer comprising ionophilic polyoxyalkylene units.

8. The polymer electrolyte as claimed in claim 7 wherein said second polymer is positioned between said lattice of said plurality of main-chain first and second repeating units.

9. The polymer electrolyte as claimed in anyone of claims 1 to 8 wherein the polymer electrolyte comprises a mixture of 15 to 25 mol % of said main-chain first repeating unit and 75 to 85 mol % of said main-chain second repeating unit.

10. A copolymer comprising repeating units being represented by general formula (1) and (2): 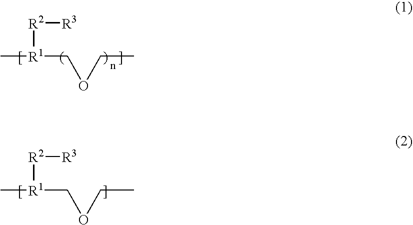
where R¹ is alkylene or a benzene nucleus; R² is oxygen, nitrogen, alkylene, phenylene or CH₂; R³ is alkyl, phenyl or alkyl-phenyl and 8≧n≧2, preferably n is 5.

11. The copolymer as claimed in claim 10 wherein R¹ is a benzene nucleus, R² is oxygen and R³ is a substantially straight chain hydrocarbon preferably —(CH₂)ₘ—H where 30≧m≧5, more preferably m is 12, 16 or 18.

12. The copolymer as claimed in claim 10 wherein R¹ is CH, R² is oxygen and R³ is a substantially straight chain hydrocarbon preferably —(CH₂)ₘ—H where 30≧m≧5, more preferably m is 12, 16 or 18.

13. The copolymer as claimed in claims 11 or 12 wherein said copolymer comprises a combination of said straight chain hydrocarbon where m is 12 and 18.

14. The copolymer as claimed in claim 13 wherein said copolymer comprises a 50:50 mixture of C₁₂H₂₅ and C₁₈H₃₇ substantially straight chain hydrocarbon.

15. A polymer blend comprising a first copolymer and a second copolymer, said first copolymer comprising repeating units being represented by general formula (1) and (2): 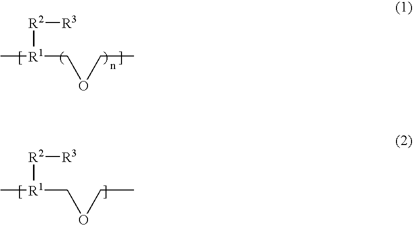
where R¹ is alkylene or a benzene nucleus; R² is oxygen, nitrogen, alkylene, phenylene or CH₂; R³ is alkyl, phenyl or alkyl-phenyl and 8≧n≧2, preferably n is 5; and
said second copolymer comprising repeating units being represented by general formula (3): 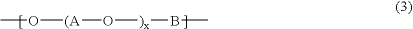
where A is alkylene or phenylene; B is alkylene, phenylene, alkylene ether, phenylene ether, alkylene-phenylene ether, alkoxy-phenylene ether or alkyl-phenylene ether; 40≧x≧20.

16. The polymer blend as claimed in claim 15 wherein R¹ is a benzene nucleus; R² is oxygen and R³ is a substantially straight chain hydrocarbon preferably —(CH₂)ₘ—H where 30≧m≧5, more preferably m is 12, 16 or 18; A is (CH₂)₄; B is a substantially straight chain hydrocarbon preferably (CH₂)ₘ or B is —O—C₆H₄—O—(CH₂)₁₂—O—C₆H₄—O—.

17. The polymer blend as claimed in claim 15 wherein R¹ is CH, R² is oxygen and R³ is a substantially straight chain hydrocarbon preferably —(CH₂)ₘ—H where 30≧m≧5, more preferably m is 12, 16 or 18; A is (CH₂)₄; B is a substantially straight chain hydrocarbon preferably (CH₂)ₘ or B is —O—C₆H₄—O—(CH₂)₁₂—O—C₆H₄—O—.

18. A polymer electrolyte being configured to provide ion transport, said polymer electrolyte comprising:
a main-chain polyether repeating unit being configured to provide ion transport;
an alkylene group or benzene nucleus being interdispersed within said polyether repeating unit;
a hydrocarbon side-chain extending from said alkylene group or said benzene nucleus, said hydrocarbon side-chain being configured to interdigitate with hydrocarbon side-chains of neighbouring polyether repeating units;
said polymer electrolyte characterised in that:
said main-chain polyether repeating unit comprises a single methylene-oxy-methylene linkage;
wherein ion transport may be provided within a coordinating channel formed by said repeating unit.

19. The polymer electrolyte as claimed in claim 18, wherein said hydrocarbon side-chain is alkyl, phenyl or a substantially straight chain hydrocarbon preferably —(CH₂)ₘ—H where 30≧m≧5, more preferably m is 12, 16 or 18.

20. The polymer electrolyte as claimed in claims 18 or 19 wherein said hydrocarbon side-chain is provided on each alkylene group or benzene nucleus of a plurality of repeating units.

21. The polymer electrolyte as claimed in claims 18 or 19 wherein said hydrocarbon side-chain extends from some of the alkylene groups or benzene nuclei of a plurality of repeating units.

22. The polymer electrolyte as claimed in any one of claims 18 to 21 wherein said polymer electrolyte is arranged as a lattice, said lattice comprising ionophilic regions of polyether repeating units and ionophobic regions of hydrocarbon side-chains.

23. A polymer comprising a repeating unit being represented by general formula (2): 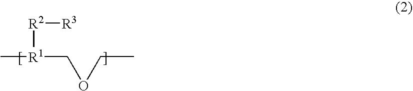
where R¹ is alkylene or a benzene nucleus; R² is oxygen or nitrogen, alkylene, phenylene or CH₂; R³ is alkyl, phenyl, alkyl-phenyl or hydrogen.

24. The polymer as claimed in claim 23 wherein R¹ is a benzene nucleus, R² is oxygen and R³ is a substantially straight chain hydrocarbon preferably —(CH₂)ₘ—H where 30≧m≧5, more preferably m is 12, 16 or 18.

25. The polymer as claimed in claim 23 wherein R¹ is CH, R²is oxygen and R³ is a substantially straight chain hydrocarbon preferably —(CH₂)ₘ—H where 30≧n≧5, more preferably m is 12, 16 or 18.

26. The polymer as claimed in claim 23 wherein R¹ is CH or a benzene nucleus, R² is CH₂ and R³ is a substantially straight chain hydrocarbon preferably —(CH₂)ₘ—H where 30≧m≧5, more preferably m is 12, 16 or 18.

27. The polymer as claimed in anyone of claims 23 to 26 further comprising a second repeating unit being represented by general formula (1): 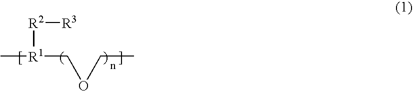
where 8≧n≧2, preferably n is 5 and wherein said formula (1) repeating unit is interspersed amongst said formula (2) repeating unit to form a mixed polyether skeletal sequence.

28. A polymer electrolyte being configured to provide ion transport, said polymer electrolyte comprising:
an ion conducting polymer being represented by general formula (2): 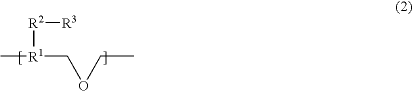
where R¹ is alkylene or a benzene nucleus; R² is oxygen, nitrogen, alkylene, phenylene or CH₂; R³ is alkyl, phenyl or alkyl-phenyl; and
an ionic bridge polymer being represented by general formula (3): 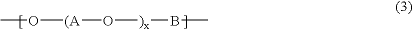
where A is alkylene or phenylene; B is alkylene, phenylene, alkylene ether, phenylene ether, alkylene-phenylene ether, alkoxy-phenylene ether or alkyl-phenylene ether; 40≧x≧20.

29. The polymer electrolyte as claimed in claim 28 wherein R¹ is a benzene nucleus; R² is oxygen and R³ is a substantially straight chain hydrocarbon preferably —(CH₂)ₘ—H where 30≧m≧5, more preferably m is 12, 16 or 18; A is (CH₂)₄; B is a substantially straight chain hydrocarbon preferably (CH₂)ₘ or B is —O—C₆H₄—(CH₂)₁₂—O—C₆H₄—O—.

30. The polymer electrolyte as claimed in claim 29 wherein R¹ is CH, R² is oxygen and R³ is a substantially straight chain hydrocarbon preferably —(CH₂)ₘ—H where 30≧m≧5, more preferably m is 12, 16 or 18; A is (CH₂)₄; B is a substantially straight chain hydrocarbon preferably (CH₂)ₘ or B is —O—C₆H₄—O—(CH₂)₁₂—O—C₆H₄—O—.

31. The polymer electrolyte as claimed in anyone of claims 28 to 30 further comprising a second repeating unit being represented by general formula (1): 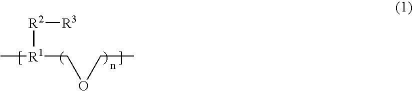
where 8≧n≧9, preferably n is 5.

32. A galvanic cell comprising a polymer electrolyte according to anyone of claims 1 to 14.

33. A galvanic cell comprising a polymer blend according to anyone of claims 15 to 17.

34. A galvanic cell comprising a polymer blend according to anyone of claims 18 to 22.

35. A galvanic cell comprising a polymer electrolyte, said polymer electrolyte comprising a polymer according to anyone of claims 23 to 27.

36. A galvanic cell comprising a polymer electrolyte, said polymer electrolyte comprising a polymer according to anyone of claims 28 to 31.

37. The galvanic cell as claimed in any one of claims 32 to 36 configured for use with lithium cations.

38. The galvanic cell as claimed in any one of claims 32 or 37 configured for use with anyone or a combination of the following anions:
ClO₄⁻, BF₄⁻, CF₃SO₃⁻ and/or (CF₃SO₂)N⁻

39. The galvanic cell as claimed in claim 38 wherein said galvanic cell is a solvent free battery.

40. The galvanic cell as claimed in claims 38 or 39 wherein electrolyte-decoupled ion transport occurs via ionophilic repeating unit channels between a cathode and anode.

41. A galvanic cell comprising a polymer electrolyte being formed from a first copolymer comprising repeating units being represented by general formula (4) and (5): 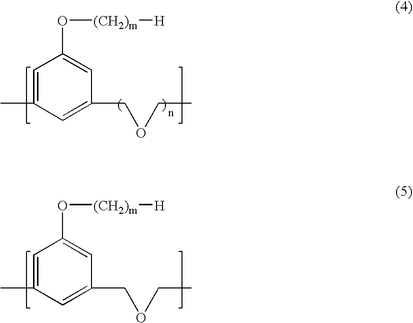
where 30≧m≧5 and 8≧n≧9, preferably m is 12, 16 or 18 and n is 5; and
a second copolymer comprising repeating units being represented by general formula (3): 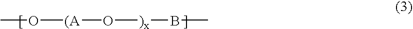
where A is alkylene or phenylene, preferably (CH₂)₄; B is alkylene, phenylene, alkylene ether, phenylene ether, alkylene-phenylene ether, alkoxy-phenylene ether or alkyl-phenylene ether;, preferably a substantially straight chain hydrocarbon, preferably (CH₂)ₘ where 30≧m≧5 or B is —O—C₆H₄—O—(CH₂)₁₂—C₆H₄—O—; 40≧x≧20.

42. The galvanic cell, comprising an electrolyte, as claimed in claim 41 further comprising a lithium salt being represented by general formula (6):
Li X (6)
where X is ClO₄⁻, BF₄⁻, CF₃SO₃⁻ and/or (CF₃SO₂)N⁻.

43. A process for the preparation of a polymer being represented by general formula (1): 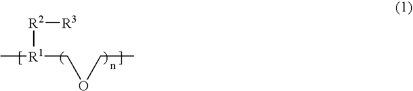
where R¹ is alkylene or a benzene nucleus, R² is oxygen, alkylene, phenylene or CH₂; R³ is alkyl, phenyl, a substantially straight chain hydrocarbon preferably —(CH₂)ₘ—H where 30≧m≧5, more preferably m is 12, 16 or 18; 8≧n≧2, preferably n is 5; said process comprising the steps of:
(a) reacting a compound being represented by general formula (7): 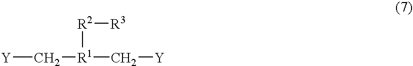
where Y is a halogen, preferably Br or Cl; with a compound being represented by general formula (8): 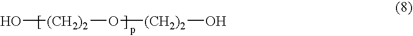
where 7≧p≧1, preferably p is 3.

44. The process as claimed in claim 43 further comprising a step of:
(b) reacting said compound of general formula (7) and general formula (8) with a compound being represented by general formula (9):

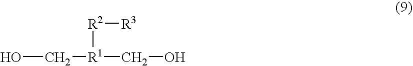

45. The process as claimed in claim 44 wherein compounds (7), (8) and (9) are reacted in a DMSO solvent or a solvent mixture of DMSO:THF

46. A process for the preparation of a copolymer, said copolymer comprising repeating units being represented by general formula (1) and (2): 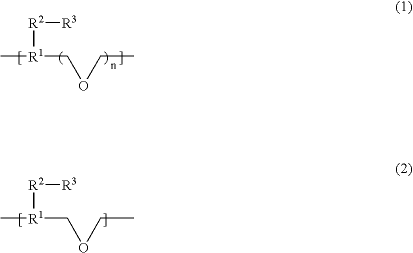
where R¹ is alkylene or a benzene nucleus; R² is oxygen, alkylene, phenylene or CH₂; R³ is alkyl, phenyl or a substantially straight chain hydrocarbon, preferably —(CH₂)ₘ—H where 30≧m≧5, more preferably m is 12, 16 or 18; 8≧n≧2, preferably n is 5
said process comprising the steps of:
(a) reacting a compound being represented by the general formula (7): 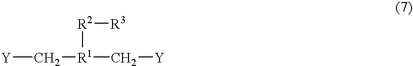
where Y is a halogen, preferably Cl or Br; with a compound being represented by general formula (8): 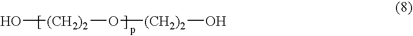
where 7≧p≧1, preferably p is 3.

47. The process as claimed in claim 46 further comprising a step of:
(b) reacting said compound of general formula (7) and general formula (8) with a compound being represented by general formula (9):

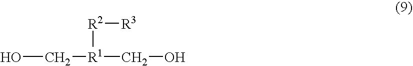

48. The process as claimed in claim 47 wherein compounds (7), (8) and (9) are reacted in a DMSO solvent or a solvent mixture of DMSO:THF

49. A process for the preparation of a compound being represented by the general formula (2): 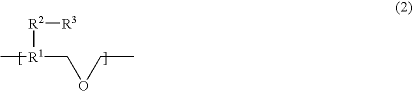
where R¹ is alkylene or a benzene nucleus; R² is oxygen, alkylene, phenylene or CH₂; R³ is alkyl or phenyl, a substantially straight chain hydrocarbon, preferably —(CH₂)ₘ—H where 30≧m≧5, more preferably m is 12, 16 or 18;
the process comprising the steps of:
(a) reacting a compound of general formula (7): 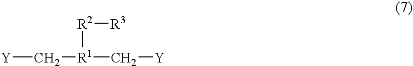
where R¹ is alkylene or a benzene nucleus, R² is oxygen, alkylene, phenylene or CH₂; R³ is alkyl, phenyl, or a substantially straight chain hydrocarbon, preferably —(CH₂)ₘ—H where 30≧m≧5, more preferably m is 12, 16 or 18; said process comprising the steps of:
with a compound being represented by general formula (9):

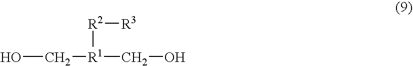

50. The process as claimed in claim 49 wherein compounds (7), (8) and (9) are reacted in a DMSO solvent or a solvent mixture of DMSO:THF

51. A process for the preparation of a polymer electrolyte comprising the steps of:
(a) forming an ion conducting polymeric material having repeating units being represented by general formula (2): 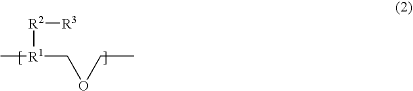
where R¹ is alkylene or a benzene nucleus; R² is oxygen, alkylene, phenylene or CH₂; R³ is alkyl, phenyl, or a substantially straight chain hydrocarbon, preferably —(CH₂)ₘ—H where 30≧m≧5, more preferably m is 12, 16 or 18;
(b) heating said polymer electrolyte above a transition temperature.

52. The process as claimed in claim 51 further comprising the steps of:
(c) prior to said heating step (b) blending compound (2) with a compound being represented by general formula (1): 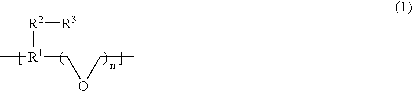
where 8≧n≧2, preferably n is 5.

53. The process as claimed in claim 51 further comprising the step of:
(d) prior to said heating step (b) blending compound (2) with an ionic bridge polymer, said ionic bridge polymer being represented by general formula (3): 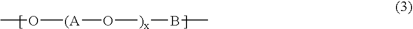
where A is alkylene or phenylene, preferably (CH₂)₄; B is alkylene, phenylene, alkylene ether, phenylene ether, alkylene-phenylene ether, alkoxy-phenylene ether or alkyl-phenylene ether;, preferably a substantially straight chain hydrocarbon, preferably (CH₂)ₘ where 30≧m≧5 or B is —O—C₆H₄—O—(CH₂)₁₂—O—C₆H₄—O—; 40≧x≧20.

54. The process as claimed in claim 52 further comprising the step of:
(e) prior to said heating step (b) blending compound (2) and compound (1) with an ionic bridge polymer, said ionic polymer being represented by general formula (3): 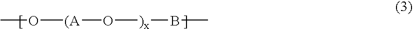
where A is alkylene or phenylene, preferably (CH₂)₄; B is alkylene, phenylene, alkylene ether, phenylene ether, alkylene-phenylene ether, alkoxy-phenylene ether or alkyl-phenylene ether;, preferably a substantially straight chain hydrocarbon, preferably (CH₂)ₘ where 30≧m≧5 or B is —O—C₆H₄—O—(CH₂)₁₂—O—C₆H₄—O—; 40≧x≧20.

55. The process as claimed in any one of claims 51 to 54 wherein said transition temperature is above a melting or glass transition temperature of compound (1).

56. The process as claimed in claim 55 wherein said transition temperature is between ambient and 110° C.

57. The process as claimed in any one of claims 51 to 56 wherein following said heating step (b) said polymer electrolyte comprises a lamellar, micellar or lamellar-micellar complex morphology.
